(19) United States
(12) Patent Application Publication
(10) Pub. No.: US 2025/0011148 A1
(43) Pub. Date: Jan. 9, 2025

(54) PAD FOR SUPPORTING WHEEL AND METHODS OF USE THEREOF

(71) Applicant: Origen RV Accessories, Ltd., Calgary (CA)

(72) Inventors: Mark Jeffrey SELANDERS, Langdon (CA); Devon WILSON, Calgary (CA)

(21) Appl. No.: 18/347,488

(22) Filed: Jul. 5, 2023

(51) Int. Cl. B66F 13/00

(52) U.S. Cl. CPC B66F 13/00

(57) ABSTRACT

A device for supporting a wheel may include a body having an upper surface and a lower surface joined by a side wall and defining a recess for cradling the wheel, wherein the lower surface has a greater surface area than a surface contact patch of the wheel.

### TECHNICAL FIELD

Aspects of the disclosure relate generally to improved pads for supporting a vehicle wheel, a caster wheel, or other wheel. The present invention further relates to methods for the manufacture of the pads as well as methods for usage.

### BACKGROUND

Typical recreational vehicles, motor homes, recreational vehicle transporting trailers, utility trailers, boat trailers, and travel trailers, are equipped with electric, hydraulic, and/or mechanical jacks which are lowered to the ground to lift or support the trailer tongue (i.e., the portion of the trailer that connects to the towing vehicle) to allow the trailer to be installed on a vehicle, to store the trailer, and/or to provide a stable, comfortable, level living environment.

The ground below the vehicle jack may vary from gravel pads, concrete or asphalt, and soft surfaces such as grass or sand. The portion of the jack, such as a wheel, that interacts with the ground below can damage such surfaces due to the force applied to the ground when the vehicle/trailer is being supported and/or is being leveled. Sinking of the wheel into the surface on which leveling, or support is attempted not only damages the surface, but also poses a safety hazard to the user. For example, the sinking of the wheel may cause difficulty or safety concerns with installing the trailer tongue onto the towing vehicle. In addition, it may be necessary to level the vehicle so that that equipment such as refrigerators and gas stoves inside the vehicle operates more efficiently and safely.

In the scaffolding industry or in other industries, wheels such as caster wheels may be provided to allow for ease of moving or otherwise transporting heavy and/or awkward objects or equipment. Frequently, casters and other transportation wheels include wheel brakes to prevent unintentional movement of the wheels. With use/wear or due to poor manufacturing, wheel brakes may be unreliable or may unnecessarily increase the cost of equipment. Further, the surface of the wheel that interacts with the ground below can damage such surfaces due to the force applied to the ground when the wheel is being supported. Sinking of the wheel into the surface on which support is attempted may not only damage the surface but may also pose a safety hazard.

Accordingly, there is a need in the art for an improved pad which mitigates these problems.

### SUMMARY

The following presents a simplified summary of one or more aspects of the technology disclosed herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects of the disclosure, the techniques described herein relate to a pad for supporting a wheel, such as a caster wheel or wheel, the pad including: a body having an upper surface and a lower surface joined by a side wall and defining a recess for cradling a wheel, wherein the lower surface has a greater surface area than a surface contact patch of the wheel.

In some aspects of the disclosure, the techniques described herein relate to a method for stabilizing awheel of a vehicle jack or caster wheel, the method including: placing a pad below the wheel and lowering the vehicle jack until the wheel is cradled within a recess of the pad, wherein the pad includes a body having an upper surface and a lower surface joined by a side wall and defining the recess for cradling the wheel, wherein the lower surface has a greater surface area than a surface contact patch of the wheel.

To the accomplishment of the foregoing and related ends, the one or more aspects of the disclosure comprise the features hereinafter fully described and particularly pointed out in the claims. The following description and the annexed drawings set forth in detail include certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

Features characteristic of aspects if the technology described herein are set forth as follows, in the appended claims, and in the drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative aspects when read in conjunction with the accompanying drawings.

FIG. 1A illustrates a jack wheel supported by a pad according to one aspect of the disclosure.

FIG. 1B illustrates scaffolding wheels supported by a pad according to one aspect of the disclosure.

FIG. 2 is a perspective view of a pad according to aspects of the disclosure.

FIG. 3A is a top view of the pad of FIG. 2 according to aspects of the disclosure.

FIG. 3B is a side view of the pad of FIGS. 2 and 3A according to aspects of the disclosure.

FIG. 3C is a cross-section B-B view of the pad of FIGS. 2, 3A, and 3B according to aspects of the disclosure.

FIG. 3D is a cross-section A-A view of the pad of FIGS. 2, 3A, and 3B according to aspects of the disclosure.

### DETAILED DESCRIPTION

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or subcombinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

As used herein, the term vehicle refers to any type of conveyance moving on wheels including, but not limited to, a recreational vehicle such as, for example, a camper, trailer, fifth wheel, toy hauler, utility trailer, or motor home.

As used herein, the term support surface refers to a surface upon which a wheel can roll and/or the vehicle is parked including, but not limited to, even and uneven surfaces such as, for example, asphalt, concrete, rock, sand, gravel, ground, soil, vegetation, grass, and the like.

### II. Overview

Recreational vehicles, motor homes, recreational vehicle transporting trailers, utility trailers, and travel trailers, are typically equipped with electric, hydraulic, and/or mechanical jacks (referred to broadly throughout this disclosure as a “vehicle jack”), which are lowered to the ground to lift or support the trailer to allow the trailer to be installed on a vehicle, to store the trailer, and/or to provide a stable, comfortable, level living environment. One example of a vehicle jack is located at or near a trailer tongue (i.e., the portion of the trailer that connects to the towing vehicle) to support and/or adjust the height of the front portion of a trailer. The vehicle jack may have a jack wheel or caster (alternatively referred to throughout this disclosure as a “wheel”) that is configured to contact the ground and/or that may assist with moving the trailer when the trailer is not connected to a towing vehicle. Since the ground below the trailer jack and wheel may vary, the current disclosure provides examples of a pad that is configured to cradle the wheel and provide a secure footing to prevent unwanted movement of the wheel and/or to prevent the wheel from sinking into the ground or surface below the wheel. The pad may additionally function as a wheel—chock to prevent the wheel from rotating or otherwise rolling unintentionally. A pad according to aspects of the disclosure is not limited to the example use above, for example, the disclosed pad may be used to stabilize or otherwise function as a wheel—chock to prevent a scaffolding or caster wheel from rotating or otherwise rolling or turning unintentionally. Further, the pad may increase the surface area of a scaffolding wheel that interacts with the ground below and/or create a cushion or otherwise isolate a scaffolding wheel from ground contact. The aforementioned increase in surface area and/or isolation of the wheel from ground contact may prevent damage to scaffolding support surfaces and/or prevent the sinking of the wheel into the surface on which support is attempted.

This overview, and the detailed description that follows, has been presented for purposes of illustration and description. It is not intended to be exhaustive nor to limit the disclosure to the forms described. Numerous modifications are possible considering the teachings herein, including any combination of the different examples described herein. Some of those modifications have been discussed and others will be understood by those skilled in the art. The various aspects were chosen and described to best illustrate the principles of the present disclosure and various aspects as are suited to the particular use contemplated. The scope of the present disclosure is, of course, not limited to the examples or aspects set forth herein but can be employed in any number of applications and equivalent devices by those of ordinary skill in the art. Rather, it is hereby intended the scope be defined by the claims appended hereto

### III. Detailed Examples

The present disclosure relates to improved pads for supporting a wheel. In one example, the pad may be used or usable to support a wheel of a vehicle jack. The components and operation of vehicle jacks are commonly known to those skilled in the art and will not be discussed in detail. In general, the jack may be hydraulically or mechanically operated, in some instances manually be a user. In other instances, the user may be provided with a control panel such as for example, a switch panel, for operating the jack. Typical electric, hydraulic, and/or mechanical jacks are capable of being extended downwardly from the underside of the vehicle towards an underlying support surface to support the vehicle, level the vehicle, and/or for raising the vehicle for hook-up to a towing vehicle. Typically, when the vehicle is to be towed and/or driven or otherwise mobilized again, the jack feet are retracted upwardly towards the underside of the vehicle and may be folded-up, allowing the vehicle to be towed and/or for the vehicle to drive-off.

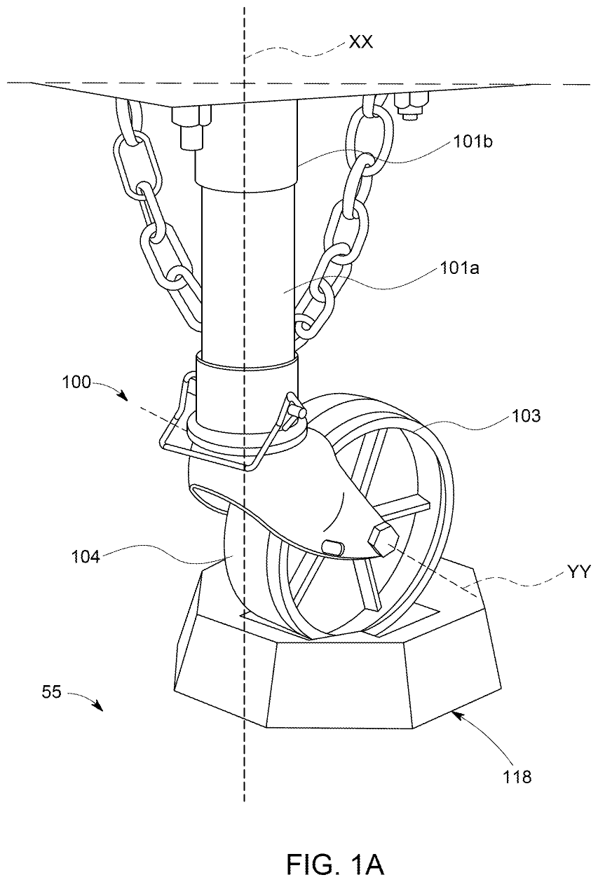

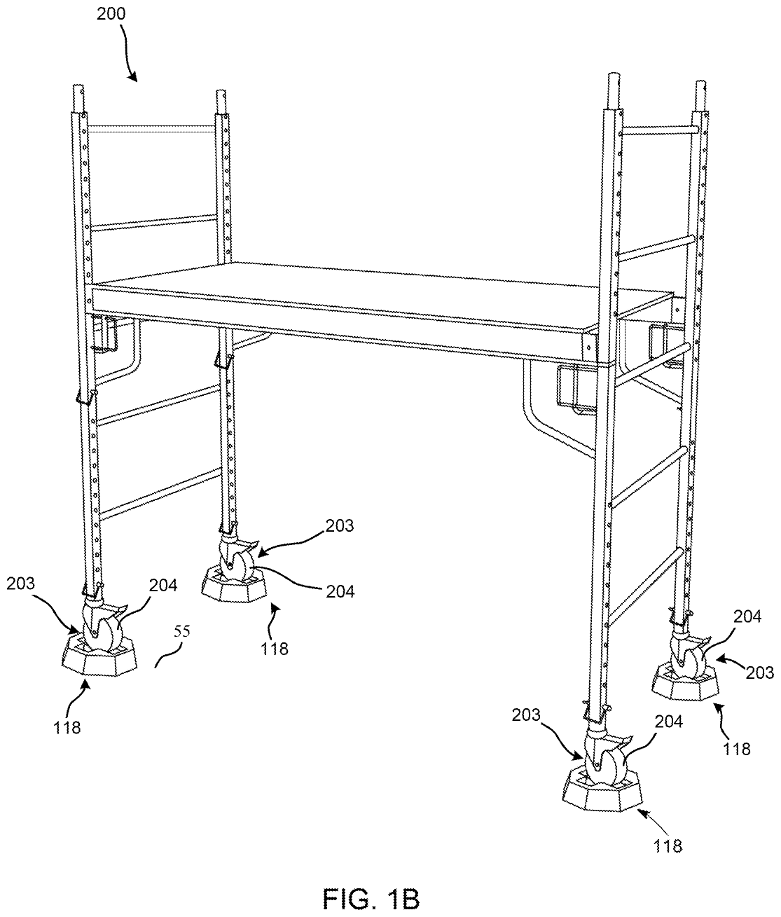

FIG. 1A illustrates a partial view of a typical vehicle jack 100 to support a vehicle. In some examples, the vehicle jack 100, which may hereinafter be interchangeably referred to simply as a jack, can typically support a weight of between about 500 pounds (“lbs”) to about 10,000 lbs or more, (the pads described below were tested to 10,000 lbs). The jack may include a telescoping first jack shaft 101a that is configured to move up/down along axis XX with respect to the second jack shaft 101b. In one example the first jack shaft 101a is an inner jack shaft that is configured to fit-with and telescope with respect to the second jack shaft 101b. While not shown in FIG. 1A, the jack 100 may include additional jack shafts that telescope with respect to one another depending on the maximum and/or minimum extension length of the jack 100. As mentioned above, the telescoping or extension of the jack 100 may be controlled via a handle (e.g., a rotatable handle to be rotated by a user) and/or may be electronically controlled (e.g., by a switch or other interface that a user controls to extend and/or retract the jack).

As shown in FIG. 1A, the jack 100 may further include a wheel 103 that allows for adjustment and or movement of the vehicle the jack is connected to. The wheel 103 may have a surface contact patch 104 and may be configured to rotate with respect to the jack about axis YY. In addition, the wheel 103 may be configured to swivel about axis XX with respect to the telescoping first jack shaft 101a and/or second jack shaft 101b.

It is noted that while wheel of a jack is provided as an example, the pad according to aspects of the disclosure not limited to such a use. Instead, the pad according to aspects of the disclosure may be used anywhere that stabilization, chocking and/or increasing the contact surface area of a wheel is desired. For example, as shown in FIG. 1B, pads 118 according to aspects of the disclosure may be used to prevent rolling, unwanted movement, damage to support surfaces, and/or sinkage of a scaffolding 200.

In some examples, the scaffolding 200 may include one or more wheels 203 that may have a surface contact patch 204. It is noted that in some aspects of the disclosure, any one of or combination of the one or more wheels may be analogous with, similar to, or may otherwise share features of the wheel 103 and/or jack 100 described herein. For example, any one or combination (e.g., two) of the wheel 203 may similarly be configured to rotate with respect to about a substantially horizontal axis (e.g., axis YY in FIG. 1A). In addition, any one or combination of the wheels 203 may be configured to swivel about a vertical axis (e.g., axis XX in FIG. 1A)

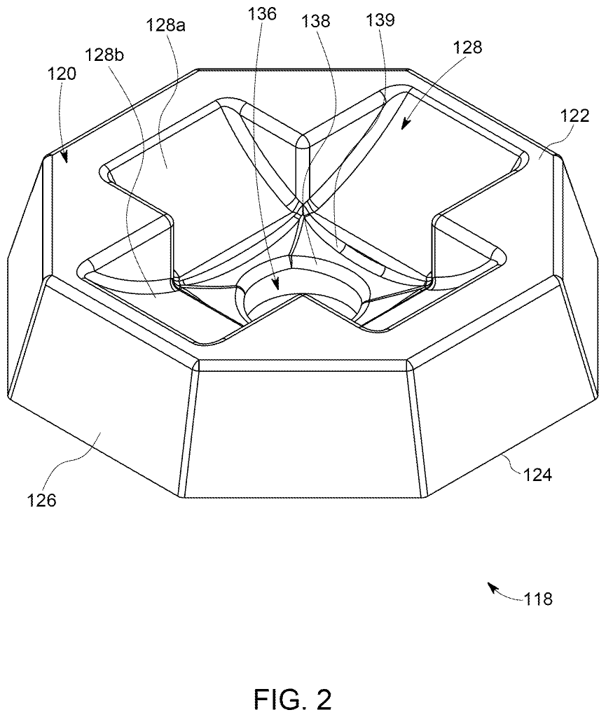

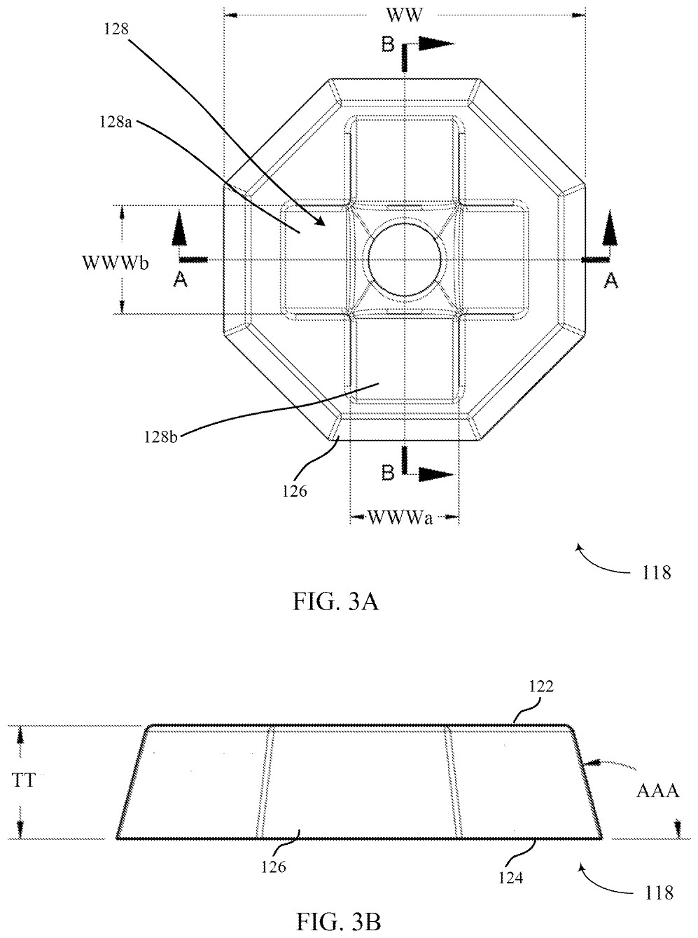

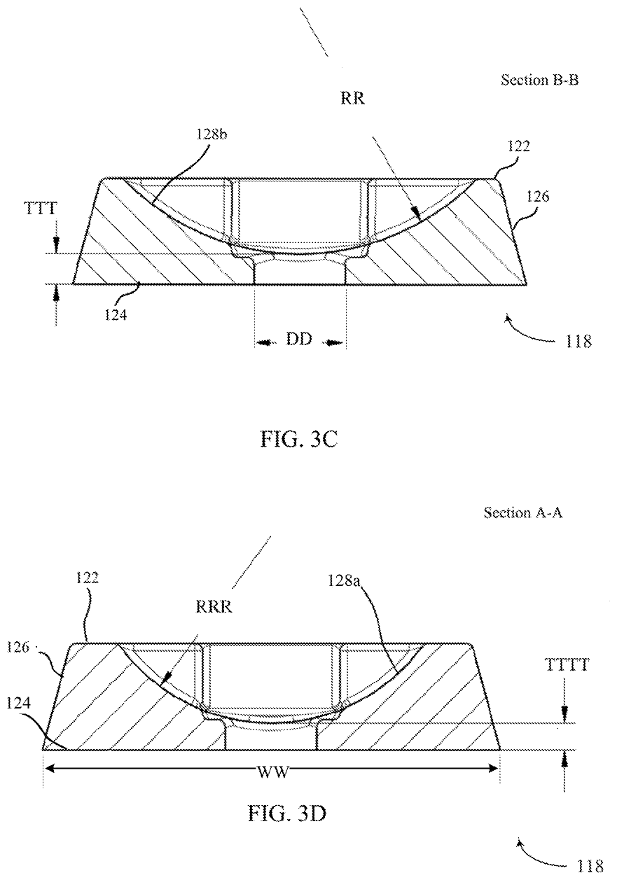

As shown in the in-use examples in FIGS. 1A and 1B, the pad 118 isolates the surface contact patch 104 and/or 204 from a ground or surface 55. Further, as shown in FIGS. 1A and 1B, the pad 118 cradles the wheel 103 and/or 203 preventing unwanted movement or rotation of the wheel 103 and/or 203 (e.g., either about axis YY and/or about axis XX shown in FIG. 1A and may also be applicable to FIG. 1B). With the pad 118 in use, the contact area with the surface 55 is increased which spreads the load that would typically be applied over a small contact area between the surface contact patch 104 and/or 204 and the surface 55 over a much larger area. Additional details of the pad 118 are described with respect to FIGS. 2-3D below.

FIGS. 2-3D generally show one example of a pad 118 disclosed herein. The pad 118 (which may hereinafter be interchangeably referred to simply as a “pad”) is shown generally to comprise a body 120 having an upper surface 122 and a lower surface 124 which are joined by a number of side walls (e.g., eight side walls 126).

The upper surface 122 is substantially flat to provide a relatively planar surface. The lower surface 124 is substantially flat to provide a relatively planar surface for the pad 118 to rest on any underlying support surface (e.g., support surface 55 in FIGS. 1A and 1B).

In one aspect of the disclosure, the side walls 126 are arranged in a generally octagonal configuration. Compared to a round configuration, an octagonal configuration may have less deflection and greater stiffness to withstand a load received from a jack as further described below under the heading Test Example. While an octagonal configuration is depicted, it will be appreciated by those skilled in the art that other shapes such as for example, circular, oval, square, rectangular, hexagonal, heptagonal, nonagonal, decagonal, and the like, are included within the scope of the disclosure.

The body 120 defines an inner recess 128 for receiving and retaining at least part of the wheel 103 and/or 203. The recess 128 may be formed in the general configuration to receive of the bottom half or less of the wheel 103 and/or 203. In the example shown in FIGS. 2-3D, the recess includes a first portion 128a for retainably holding a wheel 103 and/or 203 in a first position with the inner recess 128 and a second portion 128b for retainably holding a wheel 103 and/or 203 in a second position different from the first position. In one example, the first portion 128a and the second portion 128b may be shaped so that the first position of the wheel 103 and/or 203 is rotated ninety degrees with respect to the second position of the wheel 103 and/or 203. It is contemplated that the size, shape, and positioning of the recess 128 for an embodiment of the pad 118 may vary. Such factors relating to the recess 128 can be dictated by the dimensions the wheel 103 and/or 203.

In one aspect, the recess 128 can be positioned substantially in the center of the pad 118. The central positioning of the wheel 103 and/or 203 within the recess 128 can distribute the load of the wheel 103 and/or 203 over a larger area to prevent excess stress and potential damage to the wheel 103 and/or 203 and/or the supporting surface (e.g., surface 55 in FIGS. 1A and 1B).

As noted above, in order to retain the wheel 103 and/or 203 within either the first portion 128a and/or the second portion 128b of the recess 128, each of the first portion 128a and/or second portion 128b may have a semi-circular cross-section as best shown in FIGS. 3C and 3D. As shown in FIGS. 3C and 3D, the semi-circular cross-section of the bottom surfaces of first portion 128a and/or second portion 128b may for example have a radius RRR or RR. In some examples, radius RR may be different from radius RRR. In other examples, radius RR and RRR may be identical or substantially identical.

FIG. 3C, which shows a cross-section view about line B-B in FIG. 3A shows one example of the second portion 128b. While not intended to be limiting, in some examples, a radius RR of the second portion 128b may be from 2-7 inches. In another example, the radius RR may be from 3-6 inches. In yet another example, the radius RR may be from 3.75-4.25 inches. In one preferred aspect, the radius RR may be approximately 4.063 inches. FIG. 3D, which shows a cross-section view about line AA in FIG. 3A shows one example of the first portion 128a. While not intended to be limiting, in some examples, a radius RRR of the first portion 128a may be from 1.75-7 inches. In another example, the radius RRR may be from 2-6 inches. In yet another example, the radius RRR may be from 2.75-4.25 inches. In one preferred aspect, the radius RRR may be approximately 3.06 inches.

The first portion 128a may have first portion width WWWb (FIG. 3A). The first portion width WWWb may be from 1.5-4 inches. In another example WWWb may be from 1.8-3.5 inches. In a preferred aspect WWWb may be approximately 2.25 inches.

As shown in FIG. 3A, the cross-shaped configuration of the first portion 128a and second portion 128b allows for a wheel 103 and/or 203 to be cradled in either one of the first portion 128a and/or second portion 128b. In one aspect, the first portion 128a is configured to hold or cradle a wheel 103 and/or 203 in a first orientation and the second portion 128b is configured to hold or cradle a wheel 103 and/or 203 in a second orientation different from the first orientation. In some examples the second orientation may be between 30-110 degrees with respect to the first orientation. In a preferred aspect, the second orientation may be approximately ninety degrees or approximately perpendicular with respect to the first orientation. As noted above, in one example the first portion 128a and/or the second portion 128b may be two different sizes to accommodate different dimensions of wheels to allow for the same pad 118 to be used with multiple different types or industry standard jacks 100 and/or scaffoldings 200.

The second portion 128b may have second portion width WWWa (FIG. 3A). The second portion width WWWa may be from 1.5-4 inches. In another example WWWa may be from 1.8-3.5 inches. In a preferred aspect, WWWa may be approximately 2.25 inches.

As shown in FIGS. 3A and 3C, the lower surface 124 of pad 118 (i.e., the portion that contacts the ground or other support surface), may have a lower surface width WW. The lower surface width WW may be from 5-11 inches. In another example WW may be from 6-9 inches. In a preferred aspect, WW may be approximately 7.5 inches.

As shown in in FIG. 3B, the pad 118 may have a pad thickness TT. The pad thickness TT may be from 0.7-4 inches. In another example TT may be from 1-3 inches. In a preferred aspect, TT may be approximately 1.75 inches.

As shown in FIGS. 3C and 3D, the first portion 128a and second portion 128b may extend a depth into the pad thickness TT. In one example, the distance from the lower surface 124 to the bottom most point of the recess 128 may shown as a distance TTT or TTTT in FIGS. 3C and 3D. In some examples TTT or TTTT may be from 0.25 to 1.5 inches. In another example TTT and/or TTTT may be from 0.35-1 inches. In a preferred aspect, TTT may be approximately 0.5 inches and TTTT may be approximately 0.445 inches.

As shown in FIG. 3B, the eight side walls 126 may be angled with respect to a horizontal (i.e., a plane that is co-planar with the lower surface 124) or may be oblique with respect to the upper surface 122 and/or the lower surface 124. The angle may further help to distribute the load of the wheel placed on the pad 118 and may allow for a larger footprint. In one example, the angle AAA may be between 98-130 degrees. In another example AAA may be 100-115 degrees. In a preferred example, AAA may be approximately 105 degrees.

It is noted that the dimensional ranges provided herein are solely provided as examples—the ranges or dimension are not intended to be limiting. The dimensions of the pad 118 may be increased or decreased as may be required to satisfy any particular design objectives; for example, the pad 118 may be made available in a variety of dimensions to correspond with different sizes and shapes of wheel(s) 103 and/or 203. The pad 118 increases the footprint of the wheel 103 and/or 203, particularly the surface contact surface o be greater than surface contact patch 104 and/or 204 of the wheel 103 and/or 203 when used alone. Increasing the footprint enhances the stability and reduces sinking the wheel 103 and/or 203 into a soft or uneven underlying support surface.

The pad 118 may further include a center recessed portion 139 at the intersection of the first portion 128a and second portion 128b. the center recessed portion 139 may have a decreased thickness (i.e., a distance from the lower surface 124 to the topmost surface of the recessed portion 139) when compared to the curved sections of the first portion 128a and second portion 128b. The center recessed portion 139 may include a planar or partially curved surface that curves to join both the first portion 128a and second portion 128b. The center recessed portion 139 may further stabilize or otherwise prevent the wheel 103 from turning or otherwise moving once placed in the pad 118.

In one aspect, the body 120 defines an aperture 136. The aperture 36 can be formed in the general configuration of a circle but is not necessarily limited in shape or size. It is contemplated that the size, shape, and positioning of the aperture 136 for an embodiment of the pad 118 may vary. The aperture 136 can comprise a hole defined by a continuous rounded or chamfered edge 138 extending about the aperture 136. While a circular shape is depicted, it will be appreciated by those skilled in the art that other shapes such as for example, oval, square, rectangular, and the like, are included within the scope of the invention. The shape of the aperture 136 may or may not correspond to the exact shape of the recess 128. The aperture 136 may be provided for drainage and to prevent water from pooling in the recess 128.

In one example use of the aforementioned pad 118, a vehicle (e.g., trailer) can be driven to the desired site, such as for example, a designated campground site, storage site, etc., and maneuvered into position on the support surface, such as for example, the ground. Once the vehicle is at the desired location, the vehicle jack may be lowered either manually, using control panel within the vehicle, and/or via electric or automated controls at the vehicle jack. The user may then extend the jack towards ground and place the pad 118 under the wheel (e.g., wheel 103 in FIG. 1A) as the jack is lowered to the ground. Upon further lowering of the jack, with the wheel in a selected one of the first portion 128a and/or second portion 128b, the vehicle can be raised upwardly to a desired height from the ground. Since the pad 118 is flexible, it may conform to uneven ground. When a user wishes to to move or transport the vehicle again, the user may lower the jack further into the ground to clear a hitch of a transporting vehicle. Once the hitch connector (i.e., a hitch ball) is located in the correct position, the user can then retract the jack, from the ground and allow the tongue or other vehicle/tow vehicle interface to rest on the hitch connector. After the vehicle is properly secured to the towing vehicle, the jack may be full retracted and the pad 118 may remain on the ground. The pad 118 may be picked up by the user and stored for future use.

It will be appreciated that the pad 118 of the present invention may be simple in design but rugged in construction, such that it can be made at low cost. The upper surface 122, lower surface 124, side wall 126, recess 128, center recessed portion 139, and/or aperture 136 can be integral in construction such that the pad 118 can be formed (i.e., via shaping or additive manufacturing techniques), molded, and/or machined as a single component.

The pad 118 can be constructed from any material or combination of materials having suitable properties such as, for example, mechanical strength, ability to withstand heat, cold, moisture, and adverse conditions, and ease of manufacture. In one embodiment, the pad 118 may be constructed from a flexible, elastic material having sufficient strength and ruggedness to support the weight and withstand repeated contact with a wheel 103 and underlying support surface, to increase resistance of the pad 118 to slip, and to conform to uneven underlying support surfaces.

As used herein, the term “flexible” means capable of bending without breaking. As used herein, the term “elastomer” means a material which exhibits the property of elasticity, namely the ability to deform when a stress is applied and to recover its original form (i.e., length, volume, shape, etc.) spontaneously when the stress is removed. Elastomers typically have a low Young's modulus (i.e., the ratio of tensile stress to tensile strain, expressed in units of pressure), and a high yield strain (i.e., the stress at which a material begins to deform plastically, expressed in units of pressure). Suitable elastomeric materials may include, but are not limited to, high friction, low tack materials such as, for example, crumb rubber, natural rubber, plastic materials, elastomerics, and the like. Such materials are durable, lightweight, and relatively inexpensive.

In one aspect, the pad 118 is formed of crumb rubber. Crumb rubber is recycled rubber from automotive and truck scrap tires; thus, the pad 118 formed from crumb rubber is flexible, durable, strong, and environmentally friendly.

The pad 118 may be fabricated by a molding process including, but not limited to, injection molding and/or compression molding, or other processes known in the art. In one embodiment, the pad 118 may be cast or molded as a single piece. In one embodiment, the pad 118 may be formed of a material which readily enables indicia to be embossed on the side walls 126, or the upper or lower surfaces (122, 124); for example, indicia on the lower surface 124 may include instructions for use of the pad 118.

Example aspects of the present disclosure are described in the following Test Example, which is set forth to aid in the understanding of the disclosure and should not be construed to limit in any way the scope of the disclosure as defined in the claims which follow thereafter.

### IV. Test Example

Computer simulations were conducted to compare the deflection of round and octagonal shaped pads. Deflection is the degree to which a structural element is displaced under a load. The test load was 5000 lbs+. The simulations were based on various pressure points on the bottom of the pads. Three simulations for the round pad yielded deflections of 0.125, 0.127, and 0.206. One simulation for the octagonal pad yielded a deflection of 0.088. These results indicate that the octagonal shaped pad deflected less and exhibited greater stiffness compared to the round pad.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A pad for supporting a wheel, the pad comprising:
a body having an upper surface and a lower surface joined by a side wall and defining a recess for cradling the wheel, wherein the lower surface has a greater surface area than a surface contact patch of the wheel.

2. The pad of claim 1, wherein the recess has a semi-circular cross-sectional shape.

3. The pad of claim 1, wherein the recess comprises a first portion that is configured to cradle the wheel in a first orientation; and
a second portion that is configured to cradle the wheel in a second orientation that is different from the first orientation.

4. The pad of claim 3, wherein the second orientation is rotated approximately 90 degrees from the first orientation.

5. The pad of claim 4, wherein the first portion has a different dimension than the second portion.

6. The pad of claim 1, wherein the side wall is arranged in an octagonal configuration.

7. The pad of claim 1, further comprising an aperture extending through the body.

8. The pad of claim 1, wherein the upper surface and lower surface are substantially flat to provide relatively planar surfaces.

9. The pad of claim 1, being formed of a flexible, elastic material.

10. The pad of claim 9, wherein the material comprises an elastomeric, rubber, a crumb rubber, resin, or combinations thereof.

11. The pad of claim 1, wherein the side walls are oblique with respect to the upper surface and the lower surface.

12. A method for stabilizing a wheel, the method comprising:
placing a pad below the wheel and lowering the vehicle jack until the wheel is cradled within a recess of the pad, wherein the pad comprises a body having an upper surface and a lower surface joined by a side wall and defining the recess for cradling the wheel, wherein the lower surface has a greater surface area than a surface contact patch of the wheel.

13. The method of claim 11, wherein the wheel is cradled in a semi-circular cross-sectional recess of the pad.

14. The method of claim 13, further comprising guiding one of wheel or the pad so that the wheel is cradled in one of a first portion of the recess that is configured to cradle the wheel in a first orientation and a second portion of the recess that is configured to cradle the wheel in a second orientation that is different from the first orientation.

15. The method of claim 14, wherein the second orientation is rotated approximately 90 degrees from the first orientation.

16. The method of claim 15, wherein the first portion has a different dimension than the second portion.

17. The method of claim 1, wherein the lower surface is substantially flat to provide relatively planar surfaces and wherein the lower surface is placed on a support surface for supporting the vehicle jack when the wheel is cradled in the recess of the pad.

18. The method of claim 1, wherein the pad is formed of a flexible, elastic material to absorb any vibrations and cushion at least one of a jack support surface or the wheel.

19. The method of claim 18, wherein the material comprises an elastomeric, rubber, a crumb rubber, resin, or combinations thereof.
